(19) United States
(12) Patent Application Publication
(10) Pub. No.: US 2007/0046018 A1
(43) Pub. Date: Mar. 1, 2007

(54) Postcard Line Advertising

(76) Inventor: Chidiebere E. Ochi-Okorie, Dickinson, TX (US)

Correspondence Address: Chidiebere Ochi-Okorie, 3720 Bayou Circle, Dickinson, TX, 77539, US

(21) Appl. No.: 11/459,918

(22) Filed: Jul. 25, 2006

Related U.S. Application Data
(60) Provisional application No. 60/710,554, filed on Aug. 23, 2005.

(51) Int. Cl. B42D 15/00

(52) U.S. Cl. 283/53

(57) ABSTRACT

The invention is a method of advertising on postcard that divides a postcard into horizontal or vertical sections. Each of the said sections is ad space that is individually available for purchase by advertisers, who may submit ads to a publisher for printing in the purchased ad spaces. Contents of the postcard may direct readers to view additional details on each ad by logging on to a website.

### CROSS-REFERENCE TO RELATED APPLICATIONS

Under 35 USC 119(e)(1), this application claims priority of U.S. provisional patent application No. 60/710,554, filed on Aug. 23, 2005.

### STATEMENT REGARDING FEDERALLY SPONSORED RESEARCH

Not Applicable

### REFERENCE TO SEQUENCE LISTING, TABLE, ETC

Not Applicable

### BACKGROUND OF THE INVENTION

The invention pertains to the field of advertising, and more specifically, direct-mail advertising.

An aim of the invention is to address the problems of prohibitive advertising costs and the unavailability of high-audience advertising methods to particularly small businesses with low budgets.

### BRIEF SUMMARY OF THE INVENTION

A challenge that businesses face in general is identifying cost-effective means to advertise their products and services to an appropriate and focused group of consumers. The invention introduces a method of web-assisted direct-mail advertising that permits multiple businesses to advertise on the same postcard publication, whereby the cost of advertising is split among those businesses. By lowering the high costs of direct-mail advertising, small businesses in particular are provided an alternative over traditional advertising methods such as newspapers and handouts that generally have much lower audience densities and specificity. FIG. 1 and FIG. 2 respectively show the front side and the backside of an exemplary line-ad postcard.

### BRIEF DESCRIPTION OF THE SEVERAL VIEWS OF THE DRAWING

FIG. 1 shows the front side of an exemplary line-ad post card. Ads on this sample card are fictitious and are for demonstration purposes only.

FIG. 2 shows the backside (address side) of an exemplary line-ad post card. Ads on this sample card are fictitious and are for demonstration purposes only.

### DETAILED DESCRIPTION OF THE INVENTION

A detailed description of one embodiment of the invention is provided in the following order. First, the features of an exemplary line-ad postcard are presented. Ads published on a line-ad postcard may be submitted by advertisers to a publisher via a website that may have additional functions beyond its use for submissions. Thus a description of typical functions of such a website will follow. Then aspects of the publication and mailing process of the postcards are discussed. Finally, the differences and advantages of the invention over prior art are examined.

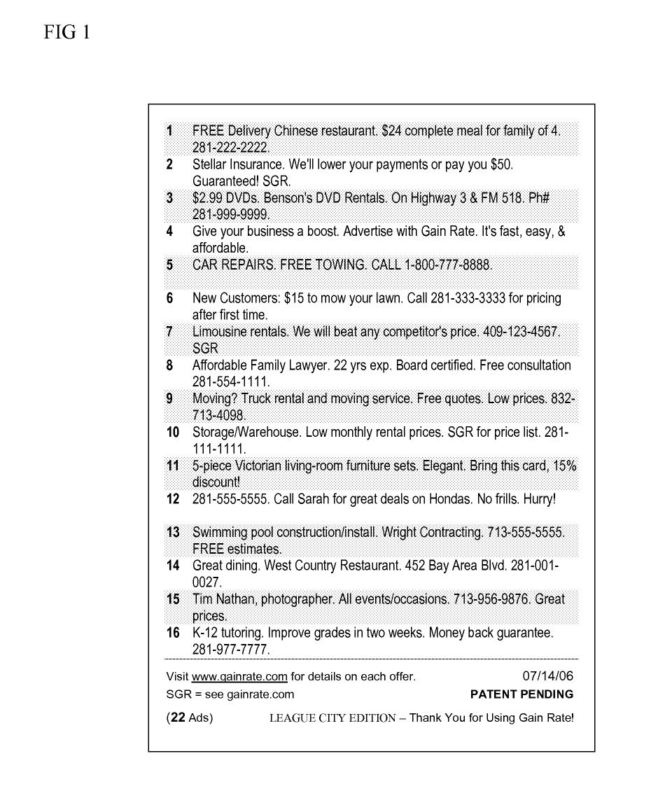

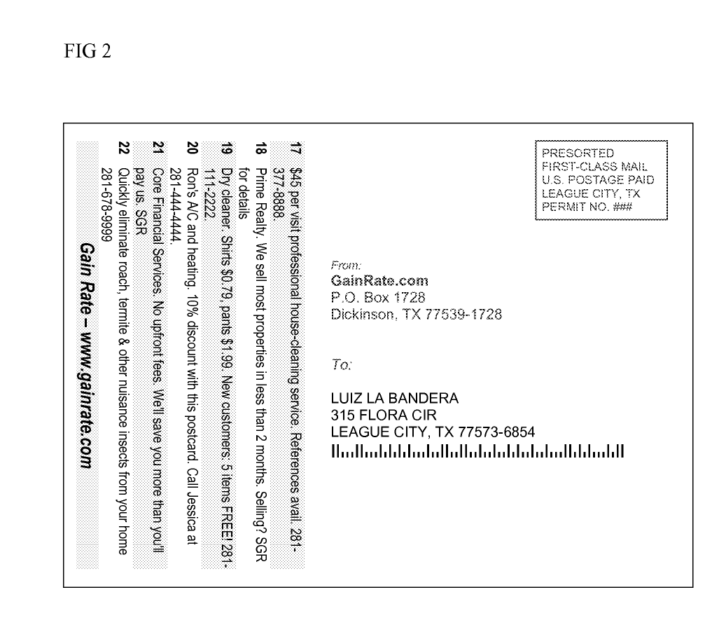

The features of the exemplary line-ad postcard shown in FIG. 1 (front side) and FIG. 2 (backside) are as follows. The line-ad postcard is divided into horizontal sections allowing for sixteen ads to be printed on the front side and six ads to be printed on the backside, totaling twenty-two ads altogether. The ads on this particular fictional postcard would have been submitted by twenty-two different businesses. The ads are numbered (1-22). This numbering permits easy referral to the ads and aids in searching or browsing an associated website for the ad in question, much using like page numbers in a book. In this embodiment, ads have a maximum length of 85 characters, including spaces and punctuation.

In addition to the ads, the front side of the postcard has a message area at the bottom. In the message area, readers of the postcard are provided a web address where they may access additional information on each ad on the postcard. Underneath the web address is a definition for an abbreviation that advertisers may use in their ads due to limited advertising space. This abbreviation is “SGR” meaning, “see gainrate.com,” where www.gainrate.com would be the website where postcard readers may access additional information on the postcard ads. Ad number 10 in FIG. 1 demonstrates the use of the abbreviation SGR. It reads, “Storage/Warehouse. Low monthly rental prices. SGR for price list. 281-111-111.” In this ad, a rental storage business is advertised. The reader is directed to see gainrate.com for a list of prices, presumably for the various sizes of storage rooms offered by the business.

On the far left of the message area is a date. This date may be the publication or mailing date of the postcard, allowing readers to easily identify or distinguish different postcard issues (publications). Beneath the date is patent information for the advertising business.

At the very bottom of the message area, on the left, is a count of the total number of ads on the postcard. In this case, the number of ads on the postcard is twenty-two. Normally, this number will not change. On the right side is information identifying the city to whose residents the postcards were mailed. In this case, the mailing list is compiled by city (League City, Tex.) and possibly by additional criteria to be discussed. A thank-you message is displayed next to the city-edition information.

On the backside of the postcard shown in FIG. 2 are additional ads, including a sponsor area; and then the address area occupies the remainder of the postcard. The sponsor area is at the very end of the postcard, underneath the regular ads. In this example, it contains the text, “Gain Rate—www.gainrate.com”. The sponsor area is available for purchase as ad space, much like regular ads. However, the message in the sponsor area is emphasized with larger and heavier print, permitting the message to stand out. In addition to the emphasis of text in the sponsor area, a sponsor may be provided with a specially designed web page(s) that showcases the sponsor's products and/or services. An advertiser may “sponsor” a postcard by advertising in the sponsor area. The cost of advertising in the sponsor area is generally higher than the cost of regular ads.

Continuing to examine FIG. 2, the back or address side of the postcard has three elements. A permit imprint, a return address, and the mailing address of the recipient. The return address and mailing address are self-explanatory. The permit imprint is an efficient alternative to stamps that allows one payment for bulk mail at a postal service station, as opposed to affixing stamps or indicia to each postcard. The same permit imprint is printed on each postcard along with the ads. The mailing address on each postcard is unique, and so may be printed at a different time from the rest of the content.

A website may be employed to facilitate the processes of postcard line advertising. A description of such a website now follows. Primary functions of the website include enabling advertisers to easily submit ads to a publisher; displaying ads for online customers or viewers; displaying publication schedules and announcements; and permitting general communication between involved parties.

In order to submit an ad, an advertiser logs on to the said website and navigates to the ad submission pages. During the ad submission process, the advertiser is prompted for his/her name, business name (if applicable), contact information, payment information, and finally text that will comprise the advertisement. In addition to submitting text for a postcard line ad, the advertiser may submit a comparatively lengthy text that provides details on the shorter postcard line ad. This additional information is of course not published on the postcard, where space is limited. Instead, it is made available online for prospective customers seeking more information on the print postcard advertisement. In one embodiment, the maximum length of a postcard ad is 85 characters, whereas the online ad details may be as long as 1500 characters, or approximately one page.

During the ad submission process, an advertiser will also select one or more mailing lists by which the postcards will be addressed. Mailing lists may be organized by city, zip code, and/or other criteria, examples of which are level of income of a household and property value for homeowners. In selecting a mailing list, an advertiser may choose to advertise in a city where the advertiser's business is located. As another example of list selection, an advertiser may select a mailing list of solely home owners if the business is house-related such as home-remodeling and repairs, lawn mowing, and security alarm installation. In one embodiment, up to 22 businesses may select the same mailing list, as each postcard will hold a maximum of 22 ads.

When advertisers submit ads to a publisher, the publisher may review the ads to validate the appropriateness of their messages before mass mailing. Ads that may be regarded by the general public to be controversial, unethical, or otherwise inappropriate may not be permitted on the postcard. Advertisers are provided feedback on the approval or rejection of their submissions by means such as a web posting of approved ads or by e-mail.

After enough ads have been collected and validated for a particular postcard publication or issue, the ads are published on postcard and mailed. At this time, the ads are also made available on the website for online viewers. In one format of online display, the postcard ads are listed on a web page with the same references (usually numbers from 1-22) shown on the print postcard. Links are provided next to each ad. Online viewers may click the link next to an ad in order to view the additional details provided for that ad, if any. When submitting an ad, advertisers are provided the opportunity to submit additional details for their ads. In one embodiment, the ad details for an ad may be as long as 1500 characters, or approximately one page.

The website may keep track of the number of times online viewers have clicked the link for each in order ad to view the details for that ad. This number is the “view count” for that ad. The view count for an ad may be displayed next to the ad and is useful to advertisers in estimating the success of their ads online. The view count may also be useful to prospective customers who may decide to review the details of an ad depending on its popularity. The view count algorithm on the website may be programmed with intelligence to exclude multiple counts from the same viewer for each ad.

One primary purpose of the website is to provide information and announcements governing the operation of the website's functions. Notably, ads may be published and mailed on a periodic basis such as bi-weekly or monthly; and thus a schedule may be made available on the website that shows target publication dates for each postcard issue. Other dates such as a submission deadline, refund deadline, and end of online display time may be associated with each publication date. The submission deadline is the latest time when ads may be submitted by advertisers for an upcoming postcard issue. The refund deadline is the latest time when an advertiser may cancel a submitted ad and request a refund. An ad may be displayed online starting from the date of its publication or mailing until the end of the online display time.

After individual advertisers have submitted ads, the ads are then compiled for postcard publication. Of note is that the postcards may be prepared and printed as automation bulk mail, thereby permitting postage discounts from the postal service. Preparation of the postcards as automation bulk mail includes verifying addresses in the mailing list for accuracy and printing barcodes next to each address on each postcard. Addresses are verified in order to identify and correct typographical or format errors and to update addresses for individuals that have moved to a new residence or have changed address. Address verification entails use of software that compares addresses in the mailing list to those in a database maintained by the postal service. The use of a permit imprint or indicia that is printed on the postcards instead of stamps also facilitates the automation process.

The preceding was a description of the technical aspects of the invention, including the features of a line-ad postcard, an associated website, and bulk mail preparation. Following is a comparison between this invention and what is already practiced, with the advantages of the invention over prior art being highlighted.

The first distinction to be made is between line-ad postcards and the more familiar types of postcards. Many publishers, including those on the internet, offer postcard packages with various features. These publishers, however, prepare postcards and bulk mail for individual businesses per postcard publication. No known publisher offers a service where multiple businesses may advertise on the same postcard publication by purchasing ad space on a postcard. One of the main advantages of a line-ad postcard over a single-ad postcard is a much lower cost of mailing. In a typical scenario, a line-ad will be about 15 times less expensive than a full-card ad. Therefore, instead of paying a few thousand dollars for a full-card ad, a small business will be more willing to advertise by line ad for not more than a few hundred dollars. The more affordable cost of line-ad advertising permits repeat advertising despite low budgets, thereby creating more exposure for the advertiser.

In one embodiment of the invention, advertisers may only submit text ads without graphics. This arrangement eliminates graphics design time and costs generally associated with postcard publication, thereby simplifying the advertising process and lowering costs.

Some of the web-based features of this advertising technique are also important distinctions from other methods of advertising. One web-based features is the ability for advertisers to provide more extensive information online regarding their print ads. Another related web-based feature is the view count functionality that tracks the number of prospective customers that have viewed this information. A reference to the web site is printed on the postcards, directing readers to visit the website. The website tracks the amount of traffic to each ad and makes this information available to both prospective customers and advertisers. Advertisers may use this information to gauge the success of their ads.

In effect, the strategy of line-ad postcard advertising is to provide key points of a business in a postcard line ad. These key points are features of the business that prospective customers will find attractive. A prospective customer who has developed interest in the ad may then visit the website to access the details of the print postcard ad. The result is low-cost internet advertising that is driven by an affordable postcard ad.

Direct mail advertising has the notable advantage over many other media, including newspaper, in that people check their mail regularly, whereas the need to frequent other media is not as significant. Ads in a newspaper, for example, will be expected to have far less exposure in a given geographical area than direct mail ads in the same geographical area. Furthermore, the ads on a line-ad postcard are short and easy to read, and a postcard has only two sides. The postcards are small and are easily taken along for reference. Thus, readers of a line-ad postcard are more likely to read all the ads, whereas ads in a newspaper, especially smaller ads, will tend to be crowded out of the reader's attention by other content.

Factors that contribute to the lessened effectiveness of newspaper ads in comparison to direct mail include distribution and interest. Direct mail, by its very nature, delivers mail to each potential consumer, free of charge. In contrast, many newspapers require purchase. Other free newspapers, especially those devoted to advertisement, may be picked up at newsstands, which is a passive method of distribution. Only consumers who are aware of and are actively seeking products and services advertised in these papers will make use of these papers.

In comparison to fliers and other handouts such as door hangers, postcard line-ads have the following advantages. Postcard line-ads can reach recipients in restricted-access neighborhoods, for example, where advertising companies may not be permitted to place door hangers or distribute other materials. Further, the time and labor costs for handout advertising will generally be much higher than the cost of mail advertising, particularly line-ad postcard advertising.

Another important advantage of direct mail over many other media is its targeting ability. Mail recipients may be selected according to a number of criteria including physical location, home ownership, property value, income level, cultural and religious affiliations, and many other criteria. Thus direct mail may be focused on a group of recipients to whom the advertised products and services will be most relevant.

Given the low costs of postcard line-ads, business can afford to both advertise and to provide incentives to customers such as free products, money-back guarantees, discounts, and use of the line-ad postcard as a coupon. By including such incentives in their line-ads and employing the targeting ability of direct mail, advertisers may maximize the value of their mail ads to prospective customers while minimizing any perception of the advertising as junk mail.

Incidentally, the online traffic generated by postcard advertising creates an opportunity for very inexpensive web-based advertising that is not connected to a postcard line ad. Small businesses and individuals with low budgets may advertise on the website at low cost without need to purchase ad space on a line-ad postcard.

An embodiment of the invention has been described above. This embodiment is only one example of many variations possible with the invention and thus does not limit the scope and applicability of the invention.

What is claimed is:

1. A method of advertising where postcards of identical ad content are mailed to a pre-selected group of recipients;
The selection of the recipients based on one or more common traits among the recipients that are of interest to advertisers, examples of those traits including but not limited to geographical location, age range, income level, and home ownership;
The postcard graphically divided into horizontal or vertical sections;
Each of the said sections of the postcard being ad space that is individually available for purchase by advertisers;
And means by which an advertiser who purchases an ad space may submit an ad to a publisher for printing on the ad space.

2. The method of advertising of claim 1 where advertisers submit text-only ads.

3. The method of advertising of claim 1 where advertisers may submit ads that contain any combination of text and graphics.

4. The method of advertising of claim 1 whereby the means of ad space purchase and ad submission is via a website.

5. The method of advertising of claim 1 where the ads printed on postcards are also displayed on a website for online viewers.

6. The method of advertising of claim 5 where advertisers are provided means via a website for posting additional information regarding their print postcard advertisement, such information being made available to prospective customers via the website.

7. The method of advertising of claim 6 wherein postcard ads are printed with unique numerical or other references, and the corresponding online ads are also associated with these references, permitting readers to easily locate a postcard ad on the website by browsing or searching, using the said references.

8. The method of advertising of claim 6 whereby the website tracks the approximate number of times that prospective customers have viewed each advertisement and provides this information to interested parties.
